(19) United States
(12) Patent Application Publication
(10) Pub. No.: US 2015/0138760 A1
(43) Pub. Date: May 21, 2015

(54) MIRROR WITH ILLUMINATION LAMP

(71) Applicant: LSI COOLER CO., LTD., TOKYO (JP)

(72) Inventor: RYUICHI YOSHIKAWA, TOKYO (JP)

(21) Appl. No.: 14/543,177

(22) Filed: Nov. 17, 2014

(30) Foreign Application Priority Data
Nov. 18, 2013 (JP) 2013-237592

(51) Int. Cl. F21V 33/00; F21V 8/00; F21V 29/00

(52) U.S. Cl. CPC F21V 33/004; F21V 29/004; G02B 6/0011
USPC 362/135

(57) ABSTRACT

An object of the present invention is to provide a mirror with an illumination lamp that ensures visibility of a mirrored surface in a dark place and a humid place by using LEDs, and that exhibits excellent LED attachment/detachment performance. The mirror with an illumination lamp according to the present invention includes a mirror main body 1, a plurality of LEDs 5, and a circuit board 3. The plurality of LEDs 5 are disposed on one surface S31 of the circuit board 3 and are integrated by the circuit board 3. The circuit board 3 has another surface S32, on a rear side of the one surface 31, with this other surface S32 facing a back surface S12 on the opposite side to the mirror surface S11 of the mirror main body 1.

### TECHNICAL FIELD

The present invention relates to a mirror with an illumination lamp that ensures visibility of a mirrored surface in a dark place and a humid place by using light emitting diodes (LEDs), and that exhibits excellent LED attachment/detachment performance.

### BACKGROUND ART

To ensure visibility of a mirrored surface in a humid place, such as a sink and a bathroom, or a dark place, mirrors needs to have a unit for heating the mirrored surface to prevent condensation and a unit for illumination.

For example, Japanese Patent Application Laid-open No. 2011-015909 discloses a mirror including such units. The mirror disclosed in Patent Document 1 includes LEDs, as the unit for preventing condensation of the mirrored surface and the unit for illumination, disposed on a back surface of the mirror.

However, in the mirror disclosed in Japanese Patent Application Laid-open No. 2011-015909, the LEDs need to be attached and detached individually to and from the back surface of the mirror. Thus, when a plurality of LEDs are attached or detached, the attachment/detachment operation for the LEDs may take time. Thus, the mirror disclosed in Japanese Patent Application Laid-open No. 2011-015909 has room for improvement in facilitating the attachment/detachment operation for the LEDs to shorten the time required for the attaching/detaching operation for the LEDs.

An object of the present invention is to provide a mirror with an illumination lamp that ensures visibility of a mirrored surface in a dark place and a humid place by using LEDs, and that exhibits excellent LED attachment/detachment performance.

### DISCLOSURE OF THE INVENTION

To achieve the object described above, a mirror with an illumination lamp according to the present invention includes a mirror main body, a plurality of LEDs, and a circuit board. The plurality of LEDs are disposed on one surface of the circuit board, and are integrated by the circuit board. The circuit board has another surface on a rear side of the one surface, with this other surface facing aback surface on a rear side of a mirrored surface of the mirror main body.

In the mirror with an illumination lamp including the mirror main body and the plurality of LEDs, the plurality of LEDs can be used as a light source and a heat source. As a result, the mirror with an illumination lamp can ensure visibility of the mirrored surface in a dark place and a humid place.

The mirror with an illumination lamp includes the circuit board. The plurality of LEDs are disposed on the one surface of the circuit board, and are integrated by the circuit board. Thus, in the mirror with an illumination lamp, the plurality of LEDs can be collectively operated through the circuit board. Accordingly, excellent LED attachment/detachment performance can be exhibited, and thus the time required for the LED attachment/detachment operation can be shortened, compared with a type where the plurality of LEDs are operated individually.

The circuit board has the other surface on the rear side of the one surface, with this other surface facing the back surface on the rear side of the mirrored surface of the mirror main body opposite. Thus, the circuit board can transmit heat from the plurality of LEDs to the mirror main body without obstructing the mirrored surface. Light emitting surfaces of the plurality of LEDs are not closed by the mirror main body. Thus, the light from the LEDs can be efficiently utilized for the purpose of illumination.

Preferably, the mirror main body is a metal plate and the mirror surface is formed by performing mirror finishing on one surface of the metal plate. In such a configuration, the mirror main body has both a function as a mirrored surface and a function as a highly heat conductive member, and provides an excellent function of evaporating water attached on the mirrored surface, that is, preventing condensation of the mirrored surface.

Preferably, each of the LEDs has a heat radiating surface in contact with the circuit board. In such a configuration, each of the LEDs can efficiently transmit heat radiated along with the light emission to the circuit board.

Preferably, the mirror with an illumination lamp includes a light guiding unit that guides the light emitted by the LEDs so that a periphery of the mirror surface of the mirror main body is illuminated. The mirror with an illumination lamp having such a configuration can certainly ensure visibility of the mirrored surface in a dark place, with the light emitted by the LEDs.

As described above, the present invention can provide a mirror with an illumination lamp that ensures visibility of a mirrored surface in a dark place and a humid place by using LEDs, and exhibits excellent LED attachment/detachment performance.

The configuration and the advantages of the present invention are described more in detail by referring to the attached drawings that are merely an example.

### BRIEF DESCRIPTION OF THE DRAWINGS

The foregoing and other objects, features and advantageous of the present invention will be better understood from the following description taken in connection with the accompanying drawings, in which;

FIG. 1 is an outer perspective view of a mirror with an illumination lamp according to an embodiment of the present invention.

FIG. 2 is an exploded front perspective view of the mirror with an illumination lamp shown in FIG. 1.

FIG. 3 is an exploded rear perspective view of the mirror with an illumination lamp shown in FIG. 1.

FIG. 4 is a cross-sectional view taken along a line 4-4 in FIG. 1.

### BEST MODE FOR CARRYING OUT THE INVENTION

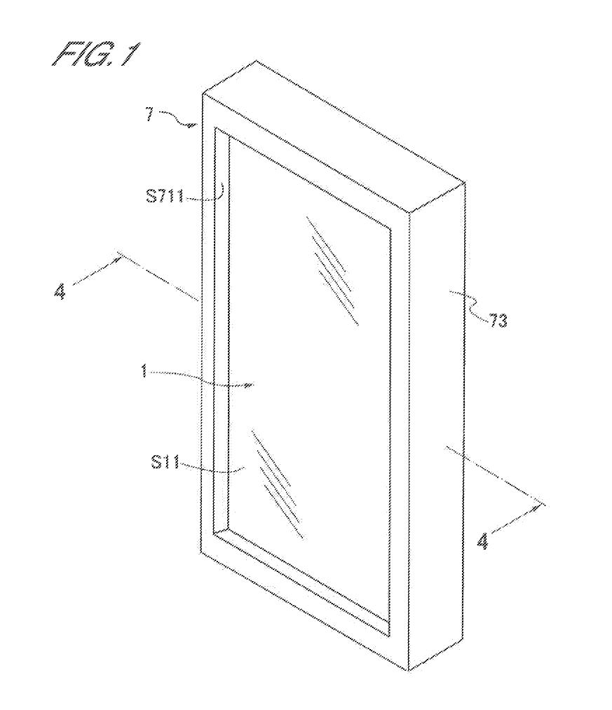

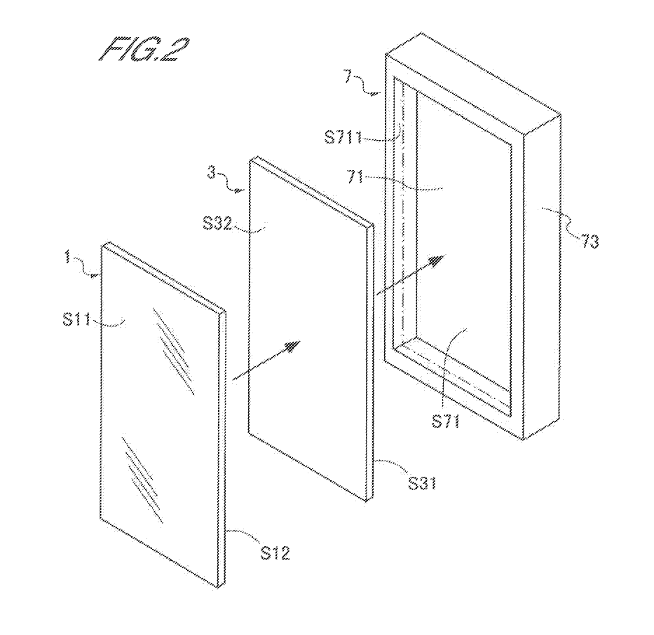

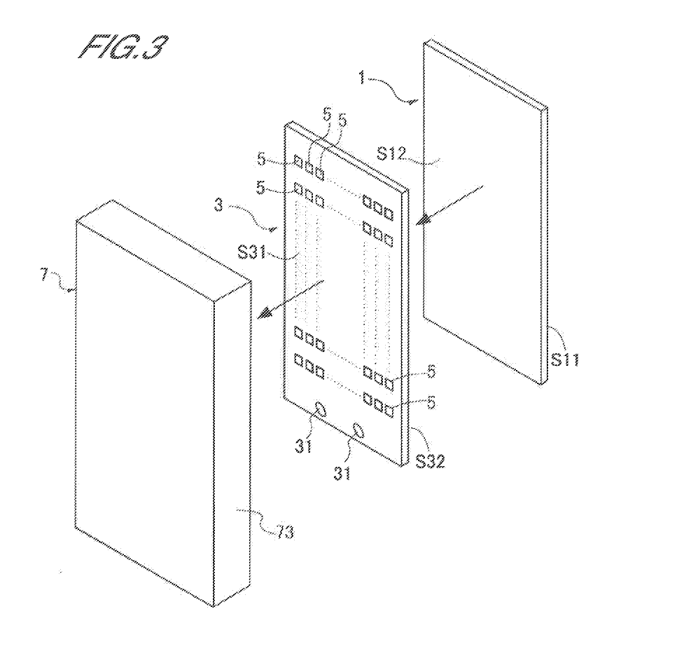

In FIGS. 1 to 4, the same or corresponding portions are denoted with the same reference numerals. As shown in FIGS. 1 to 4, a mirror with an illumination lamp according to the present invention includes a mirror main body 1, a plurality of LEDs 5, a circuit board 3, and a light guiding unit 7.

The mirror main body 1 includes a mirrored surface S11 that reflects a target object and a back surface S12 on the opposite side of the mirrored surface S11. The mirror main body 1 is a metal plate of a single layer that exhibits excellent thermal conductivity than a glass plate (having high thermal conductivity for example). The metal plate is preferably an aluminum plate, a copper plate, or an alloy plate of these that is advantageous in terms of cost. The mirrored surface S11 is formed by performing mirror finishing on one surface of the metal plate. Preferably, surface coating is implemented over the mirrored surface S11 for damage prevention.

The mirror main body 1 is set to have a thickness whereby heat from the back surface S12 is transmitted over the entire mirrored surface S11 and condensation of the mirrored surface S11 is prevented. The mirror main body 1 has a rectangular contour in the figure, but may have the contour of a different shape such as a circular shape or a star shape.

The use circuit board 3 is a conventional circuit board provided with an insulating substrate with electrodes 31 and a wiring pattern (not shown) . By connecting a terminal (not shown) of an external power source to the electrode 31 in the circuit board 3, power can be supplied to electronic components mounted to one surface S31 of the circuit board 3 through the wiring pattern.

The circuit board 3 has another surface S32 on the rear side of the one surface S31, with this other side facing the back surface S12 of the mirror main body 1. The circuit board 3 is detachably attached to the back surface S12 of the mirror main body 1 by a known method. The other surface S32 of the circuit board 3 is indirect contact with the back surface S12 of the mirror main body 1.

As shown in the figure, the shape and the area of the one surface S31 and the other surface S32 of the circuit board 3 are the same as those of the back surface S12 of the mirror main body 1. However, this should not be construed in a limiting sense. The circuit board 3 may have any shape and size. For example, the one surface S31 and the other surface S32 of the circuit board 3 may have an area that is not larger than half the area of the back surface S12 of the mirror main body 1. Thus, the circuit board 3 has such a size that the back surface S12 of the mirror main body 1 can be covered by a plurality of circuit boards 3. The circuit board 3 has such a thickness that heat radiated by the electric components mounted to the one surface S31 can be transmitted to the other surface S32.

The plurality of LEDs 5 are arranged in an N×M matrix (N and M being integers satisfying the following relationships N+M≧3, N≧1, and M≧1) on a side of the one surface S31 of the circuit board 3. The LEDs 5 are integrated by the circuit board 3. The LEDs 5 may not necessarily be arranged in a matrix. The LEDs 5 may be randomly arranged.

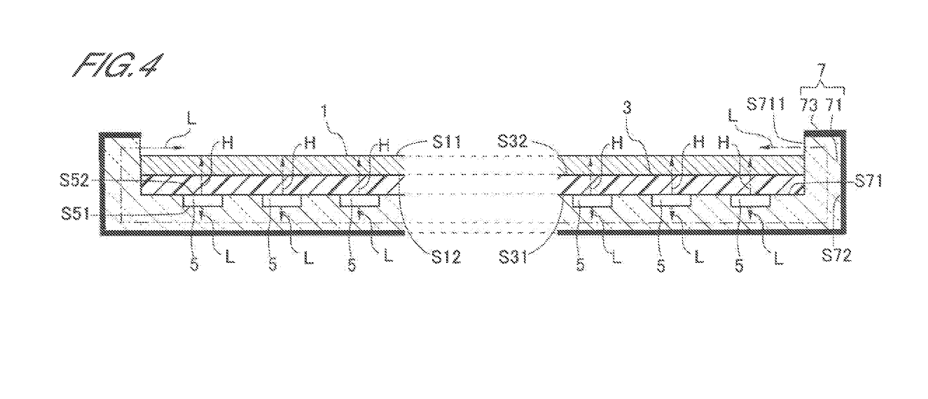

Each of the plurality of LEDs 5 is a red LED, a green LED, or a blue LED. The outer surfaces of the plurality of LED 5 are each segmented into a light emitting surface S51 (FIG. 4) and a heat radiating surface S52 (FIG. 4). The heat radiating surface S52 is a portion of the outer surface of the LED 5 other than the light emitting surface S51.

Each of the plurality of LEDs 5 has the light emitting surface S51 facing the side opposite to the mirror main body 1. The LED 5 is mounted on the circuit board with the heat radiating surface S52 in direct contact with the one surface S31 of the circuit board 3. Each of the LEDs 5 is connected to the wiring pattern of the circuit board 3. Each of the LEDs 5 emits red, green, or blue light L (FIG. 4) from the light emitting surface S51 upon receiving power through the wiring pattern, and radiates heat H (FIG. 4), produced along with the light emission, from the heat radiating surface S52. The heat H, radiated by the plurality of LEDs 5 along with the light emission, is transmitted to the circuit board 3 through a portion of the heat radiating surface S52 of the LED 5 in contact with the circuit board 3. The heat H is further transmitted toward the mirrored surface S11 from the back surface S12 of the mirror main body 1 to heat the mirrored surface S11. The mirrored surface S11 is heated, and thus condensation is prevented.

The light guiding unit 7 includes a light transmitting section 71 and a light reflecting section 73. The light transmitting section 71 is formed by bending a general use light guide panel. The light transmitting section 71 transmits the light L emitted from the light emitting surfaces S51 of the plurality of LEDs 5. The light transmitting section 71 has an inner circumferential surface S71 covering the entire side surface of the mirror main body 1, the entire side surface of the circuit board 3, the one surface S31, and the light emitting surfaces S51 of the plurality of LEDs 5. The inner circumferential surface S71 of the light transmitting section 71 has a light outgoing surface S711 standing from the peripheral edge of the mirrored surface S11 of the mirror main body 1. The light reflecting section 73 is a general use light reflection sheet. The light reflecting section 73 reflects the light L emitted from the light emitting surfaces S51 of the plurality of LEDs 5. The light reflecting section 73 covers the entire outer circumferential surface S72 of the light transmitting section 71.

The light guiding unit 7 guides the light L, emitted from the plurality of LEDs 5 and diffusely reflected by the light reflecting section 73, to the light outgoing surface S711 through the light transmitting section 71. Thus, the light L is emitted from the light outgoing surface S711 onto the mirrored surface S11 of the mirror main body 1, whereby a periphery of the mirrored surface S11 is illuminated.

The abovementioned mirror with an illumination lamp includes the mirror main body 1 and the plurality of LEDs 5. Each of the LEDs 5 emits the light L from the light emitting surface S51, and radiates the heat H produced along with the light emission from the heat radiating surface S52. Thus, the plurality of LEDs 5 can be used as a light source for illuminating the mirrored surface S11 and as a heat source for preventing the condensation of the mirrored surface S11 in a humid place. Thus, the mirror with an illumination lamp can ensure visibility of the mirrored surface S11 in a dark place and a humid place.

The mirror with an illumination lamp includes the circuit board 3. The plurality of LEDs 5 are disposed on a side of the one surface S31 of the circuit board 3, and are integrated by the circuit board 3. Thus, the plurality of LEDs 5 can be collectively operated through the circuit board 3. Accordingly, excellent attachment/detachment performance with respect to the LEDs 5 can be exhibited, compared with a type where the plurality of LEDs 5 are operated individually. Specifically, in the mirror with an illumination lamp, the plurality of LEDs 5 can be attached to and detached from the mirror main body 1 at once by attaching and detaching the circuit board 3. Thus, the mirror with an illumination lamp can shorten the time required for the attaching/detaching operation for the LEDs 5, compared with the type where the plurality of LEDs 5 are attached and detached individually.

Each of the LEDs 5 is mounted to the circuit board with the light emitting surface S51 facing the opposite side of the mirror main body 1. The light transmitting section 71 of the light guiding unit covers the light emitting surfaces S51 of the plurality of LEDs 5. Thus, the light L can be emitted toward the light transmitting section 71 from the light emitting surface S51.

Each of the LEDs 5 has the heat radiating surface S52 in direct contact with the one surface S31 of the circuit board 3. Thus, the heat H radiated from the heat radiating surface S52 along with the light emission of the LED 5 can be efficiently transmitted to the circuit board 3.

The circuit board 3 has the other surface S32 on the rear side of the one surface S31, with this other surface facing the back surface S12 on the rear side of the mirrored surface S11 of the mirror main body 1. Thus, the circuit board 3 can transmit the heat H from the plurality of LEDs 5 from the other surface S32 to the back surface S12 of the mirror main body 1 without obstructing the mirrored surface S11. Moreover, closure of the light emitting surfaces S51 of the plurality of LEDs 5 by the mirror main body 1 can be prevented. Thus, the light L from the LEDs 5 can be efficiently utilized for the purpose of illumination.

The circuit board 3 has the other surface S32 in direct contact with the back surface S12 of the mirror main body 1. Thus, the heat H radiated from the plurality of LEDs 5 can be efficiently transmitted to the back surface S12 of the mirror main body 1 through the circuit board 3.

The circuit board 3 is detachably attached to the back surface S12 of the mirror main body 1, and thus excellent operability can be achieved. For example, when an operation is made on the circuit board 3 itself or on the LEDs 5 mounted to the circuit board 3, the operation can be performed after detaching the circuit board 3 from the mirror main body 1. Thus, the operation can be performed without causing problems such as damaging the mirrored surface S11 of the mirror main body 1.

The mirror main body 1 is a metal plate of a single layer that exhibits excellent thermal conductivity that is greater than a glass plate (having high thermal conductivity for example). The mirrored surface S11 is formed by performing mirror finishing on one surface of the metal plate. In such a configuration, the mirror main body 1 has a function of a mirrored surface. The mirror main body 1 has higher performance as a heat conducting body than that made by depositing metal, such as silver or aluminum, on a back surface of a glass plate. Thus, the mirror main body 1 provides an excellent function of evaporating water attached on the mirrored surface S11, that is, preventing condensation for the mirrored surface S11. The mirror main body 1 is a metal plate of a single layer which can function as both a mirrored surface and a high thermal conductor.

On account of this, the structure of the mirror with an illumination lamp can be simplified and the downsizing of this mirror can be realized.

The light guiding unit 7 guides the light L, emitted from the plurality of LEDs 5 and diffusely reflected by the light reflecting section 73, to the light outgoing surface S711 through the light transmitting section 71. Thus, the light L is emitted onto the mirrored surface S11 of the mirror main body 1 through the light outgoing surface S711, whereby a periphery of the mirrored surface S11 is illuminated. In such a configuration, the mirror with an illumination lamp can certainly ensure visibility of the mirrored surface S11 in a dark place with the light of the LEDs 5.

The mirror with an illumination lamp according to present invention can be applied to various uses such as a sink mirror, a bathroom mirror, a full-length mirror, a door mirror, a partitioning mirror, or a ceiling mirror.

The specific content of the present invention is described above by referring to the preferred embodiment. It is apparent to a person skilled in the art that various modifications can be made based on the basic technical idea and teachings of the present invention.

1. A mirror with an illumination lamp, comprising:
a mirror main body including a mirror surface and a back surface on a rear side of said mirror surface;
a circuit board including one surface and another surface on a rear side of said one surface, said other surface facing said back surface of said mirror main body;
a plurality of LEDs disposed on said one surface of said circuit board, said plurality of LEDs having light emitting surfaces facing an opposite side to said one surface and being integrated by said circuit board; and
a light guiding unit guiding light emitted by said LEDs to illuminate a periphery of said mirror surface of said mirror main body, said light guiding unit covering said light emitting surfaces of said plurality of LEDs.

2. The mirror with an illumination lamp according to claim 1, wherein said mirror main body is a metal plate and said mirror surface is formed by performing mirror finishing on one surface of the metal plate.

3. The mirror with an illumination lamp according to claim 1, wherein each of said LEDs has a heat radiating surface that is in contact with said circuit board.

4. The mirror with an illumination lamp according to claim 2, wherein each of said LEDs has a heat radiating surface that is in contact with said circuit board.

5. The mirror with an illumination lamp according to claims 1, wherein
said light guiding unit includes a light transmitting section and a light reflecting section,
said light transmitting section transmits the light emitted from said LEDs, covers said light emitting surfaces of said plurality of LEDs, and has an outgoing surface for the light, with said outgoing surface being formed by rising from a peripheral edge of said mirror surface of said mirror main body, and
said light reflecting section reflects the light and covers an outer circumferential surface of said light transmitting section.

6. The mirror with an illumination lamp according to claims 2, wherein
said light guiding unit includes a light transmitting section and a light reflecting section,
said light transmitting section transmits the light emitted from said LEDs, covers said light emitting surfaces of said plurality of LEDs, and has an outgoing surface for the light, with said outgoing surface being formed by rising from a peripheral edge of said mirror surface of said mirror main body, and
said light reflecting section reflects the light and covers an outer circumferential surface of said light transmitting section.

7. The mirror with an illumination lamp according to claims 3, wherein
said light guiding unit includes a light transmitting section and a light reflecting section,
said light transmitting section transmits the light emitted from said LEDs, covers said light emitting surfaces of said plurality of LEDs, and has an outgoing surface for the light, with said outgoing surface being formed by rising from a peripheral edge of said mirror surface of said mirror main body, and
said light reflecting section reflects the light and covers an outer circumferential surface of said light transmitting section.

8. The mirror with an illumination lamp according to claims 4, wherein
said light guiding unit includes a light transmitting section and a light reflecting section,
said light transmitting section transmits the light emitted from said LEDs, covers said light emitting surfaces of said plurality of LEDs, and has an outgoing surface for the light, with said outgoing surface being formed by rising from a peripheral edge of said mirror surface of said mirror main body, and
said light reflecting section reflects the light and covers an outer circumferential surface of said light transmitting section.
